(19) United States
(12) Patent Application Publication
(10) Pub. No.: US 2019/0242992 A1
(43) Pub. Date: Aug. 8, 2019

(54) WARNING DEVICE AND MOBILE CARRIER ASSEMBLY

(71) Applicant: PEGATRON CORPORATION, Taipei City (TW)

(72) Inventors: Hsiao-Hao Hsu, Taipei City (TW); Shao-Yu Wang, Taipei City (TW)

(73) Assignee: PEGATRON CORPORATION, TAIPEI CITY (TW)

(21) Appl. No.: 16/250,664

(22) Filed: Jan. 17, 2019

(30) Foreign Application Priority Data
Feb. 8, 2018 (TW) 107104457

(51) Int. Cl. G01S 13/93; B60W 50/14; G08B 21/02; B60R 21/017; B60R 21/0134

(52) U.S. Cl. CPC G01S 13/931; B60W 50/14; G08B 21/02; B60R 2021/01088; B60R 21/0134; B60W 2050/143; B60R 21/017

(57) ABSTRACT

A warning device and a mobile carrier assembly are provided. The mobile carrier assembly includes a mobile carrier and a warning device mounted at the outside of the mobile carrier. The warning device includes an energy harvesting unit, a battery, an object sensor and a warning element. The energy harvesting unit is used to retrieve an energy from an environment and convert the energy into an electrical energy. The battery is electrically connected with the energy harvesting unit for storing the electrical energy. The object sensor is electrically connected with the battery and used to sense whether an object is present in a predetermined range. The warning element is electrically connected with the object sensor and used to issue an alert when the object sensor senses that an object is present in the predetermined range. The alert includes a sound or light.

### CROSS-REFERENCE TO RELATED APPLICATION

This application claims the priority benefit of Taiwan application serial no. 107104457, filed on Feb. 8, 2018. The entirety of the above-mentioned patent application is hereby incorporated by reference herein and made a part of this specification.

### BACKGROUND

### Technology Field

The disclosure relates to a warning device and a mobile carrier assembly. More particularly, the disclosure relates to a warning device and a mobile carrier assembly having the warning device.

### Description of Related Art

Blind spots during vehicle driving have always been a problem that needs to be solved. In order to solve this problem, vehicle manufacturers keep launching vehicle blind spot detection systems, and there are two methods for the blind spot detection available on the market, i.e., an image-based and a radar-based methods.

Description with respect to an image-based vehicle blind spot detection system is set forth as follows. Lenses of the image-based vehicle blind spot detection system are usually mounted on rearview mirrors and the rear of a vehicle, and then, other vehicles at the rear are monitored in an image mode. However, defects of such technique lie in that in case the weather is not good, for example, in the presence of heavy fog or rain, it causes misjudgment to the image mode. In addition, night vision technology is also another issue.

Radar-based vehicle blind spot detection systems are usually classified into two short wave radar spectrums, i.e., 24 GHz and 77 GHz, where radar sensors are installed at sides or on the rear bumper of the vehicle for sending microwaves to detect vehicles appearing by the sides or at the rear of the vehicle. The radar mode is less influenced by the weather than the image mode. The microwave is a kind of electromagnetic wave and a kind of high-frequency radio signal using the air as a transmission medium. A millimeter wave radar is applied to the vehicle for distance measurement. Because the millimeter wave radar is not easily influenced by a shape and a color of an object surface nor by the air flow and has features in favor for environment adaptability, rain, snow, fog and so on rarely interferes the millimeter wave radar. Therefore, the detection capability of the microwave has no relevance with respect to the vehicle speed.

The aforementioned image-based and radar-based vehicle blind spot detection systems cost high and thus, are not standard equipment for vehicles, but may be optionally purchased by customers based on demands, which may result in increased cost for the consumers in the purchase of vehicles. Moreover, both the image-based and the radar-based vehicle blind spot detection systems are fixed inside the vehicles and cannot be arbitrarily moved.

### SUMMARY

The disclosure provides a warning device with use convenience and low cost.

The disclosure provides a mobile carrier assembly having a warning device capable of effectively alerting pedestrians or vehicles approaching a mobile carrier.

A warning device adapted to be mounted at the outside of a mobile carrier is provided by the disclosure. The warning device includes an energy harvesting unit, a battery, an object sensor and a warning element. The energy harvesting unit is used to retrieve energy from the environment and convert it into electrical energy. The battery is electrically connected with the energy harvesting unit and used to store the electrical energy. The object sensor is electrically connected with the battery and used to sense whether an object is present in a predetermined range. The warning element is electrically connected with the object sensor and used to issue an alert when the object sensor senses that an object is present in the predetermined range. The alert comprises at least one of a sound and light.

A mobile carrier assembly including a mobile carrier and a warning device is provided by the disclosure. The warning device is mounted at the outside of the mobile carrier and includes an energy harvesting unit, a battery, an object sensor and a warning element. The energy harvesting unit is used to retrieve energy from the environment and convert it into electrical energy. The battery is electrically connected with the energy harvesting unit and used to store the electrical energy. The object sensor is electrically connected with the battery and used to sense whether an object is present in a predetermined range. The warning element is electrically connected with the object sensor and used to issue an alert when the object sensor senses that an object is present in the predetermined range. The alert includes at least one of a sound and light.

In an embodiment of the disclosure, the mobile carrier is a vehicle or a hand held electronic device.

In an embodiment of the disclosure, the energy harvesting unit retrieves solar energy, wind power or thermoelectricity.

In an embodiment of the disclosure, the object sensor is an infrared sensor.

In an embodiment of the disclosure, the warning device is further electrically connected with the mobile carrier.

In an embodiment of the disclosure, the warning element is a buzzer, an LED or a combination of a buzzer and an LED.

To sum up, the warning device is formed by using simple elements and thus, has low manufacturing cost. Moreover, the warning device can be arbitrarily mounted at the outside of the mobile carrier as a user desires to form the mobile carrier assembly.

To make the above features and advantages of the disclosure more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing a mobile carrier assembly of the invention.

FIG. 2 is a schematic view of a warning device depicted in FIG. 1.

FIG. 3A through FIG. 3C are schematic views showing that the warning devices of the mobile carrier assembly alert when a person or an object approaches the mobile carrier.

FIG. 4 through FIG. 6 are circuit block views of the warning device for blind spot detection according to different embodiments.

### DESCRIPTION OF EMBODIMENTS

For a mobile carrier, such as a vehicle, there is usually a blind spot range which is difficult for a driver to take notice of, and as the vehicle size varies, the size of the blind spot range also varies. Generally, the larger the vehicle is, the more the blind spot regions are, and the larger the range is. Regardless of a large or a small vehicle, the blind spot range is hard to be effectively prevented due to the limitations from the technical issues set forth above even though the image-based or the radar-based vehicle blind spot detection system of the related art is equipped.

However, the invention provides a warning device with less elements, simple assembly and circuit design and low manufacturing cost and is capable of being mounted at anywhere of a mobile carrier based on a user's demand for notifying people outside the mobile carrier by means of alerting, such that the people outside the mobile carrier receiving the alert are able to actively dodge the mobile carrier.

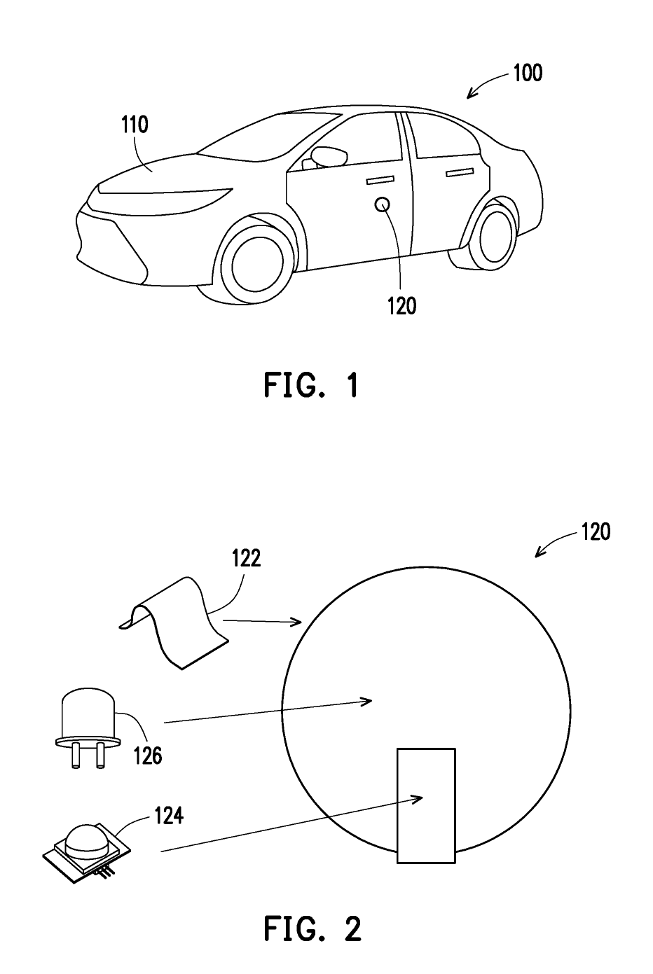

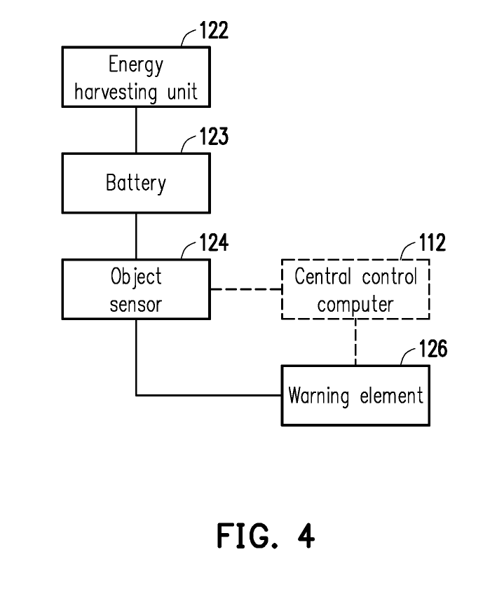

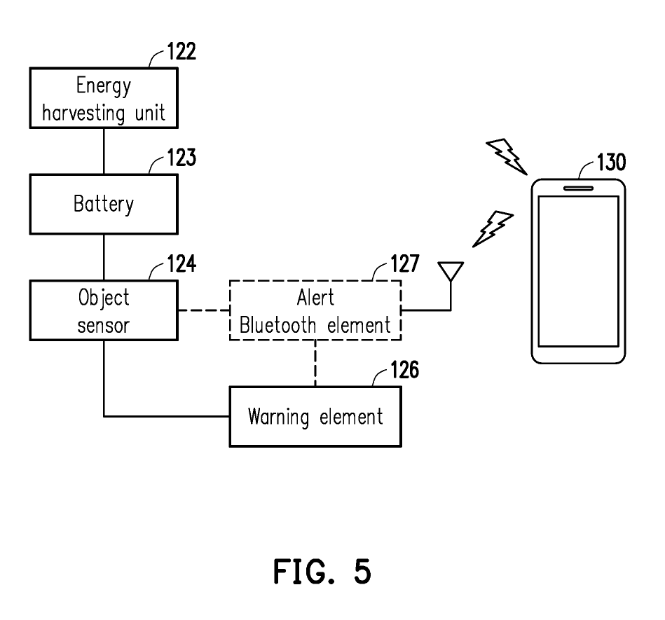

FIG. 1 is a schematic view showing a mobile carrier assembly of the invention, and FIG. 2 is a schematic view of a warning device depicted in FIG. 1. Referring to both FIG. 1 and FIG. 2, a mobile carrier assembly 100 of the invention includes a mobile carrier 110 and a warning device 120. The mobile carrier 110 of the present embodiment is a vehicle launched with oil or electricity. The warning device 120 is mounted at the outside of the mobile carrier 110 and includes an energy harvesting unit 122, a battery 123 (with reference to FIG. 4 or FIG. 5), an object sensor 124 and a warning element 126. The energy harvesting unit 122 is used to retrieve energy from the environment and convert it into electrical energy. The battery 123 is electrically connected with the energy harvesting unit 122 and used to receive and store the electrical energy converted from the energy harvesting unit 122. The object sensor 124 is electrically connected with the battery 123 and used to sense whether an object is present in a predetermined range. The warning element 126 is electrically connected with the object sensor 124 and issues an alert when the object sensor 124 senses that an unexpected person or object appears within the predetermined range, thereby warning the person or the object to dodge the mobile carrier 110.

Specifically, the energy harvesting unit 122 is, for example, a flexible solar panel, and thereby, the energy harvesting unit 122 may be tightly adhered to a casing of the warning device 120. In this way, the energy harvesting unit 122 may preferably absorb the sunlight and after the photoelectric conversion, supplies the electricity to the battery 123. Although the energy harvesting unit 122 is illustrated as the solar panel in the present embodiment, but the invention is not limited thereto. The energy harvesting unit 122 may also be used to retrieve wind power or thermoelectricity and uses an adaptive element based on a demand. In addition, the object sensor 124 of the present embodiment is an infrared sensor, and the warning element 126 may be a buzzer, an LED or a combination of a buzzer and an LED.

To follow, a user may mount the warning device 120 at the outside of the mobile carrier 110 by means of adhering, magnetically attaching or other possible manners, thereby forming the mobile carrier assembly 100, wherein the warning device 120 may be mounted at any position at the outside of the mobile carrier 110. In the present embodiment, the warning device 120 is mounted at a side, the front, the rear or any other position of the mobile carrier 110. Additionally, the number of the warning device 120 mounted on each mobile carrier 110 is also not limited to one.

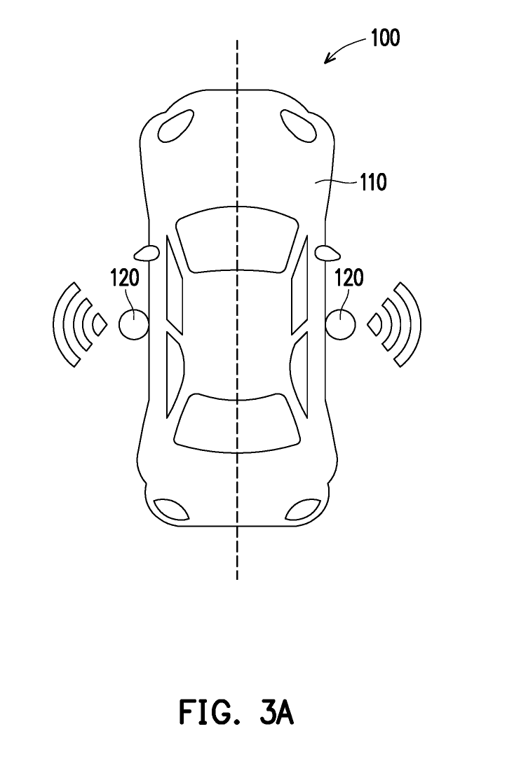

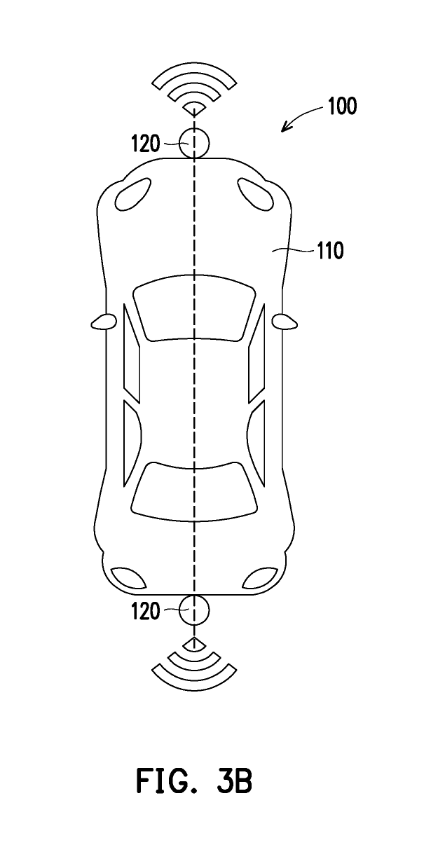

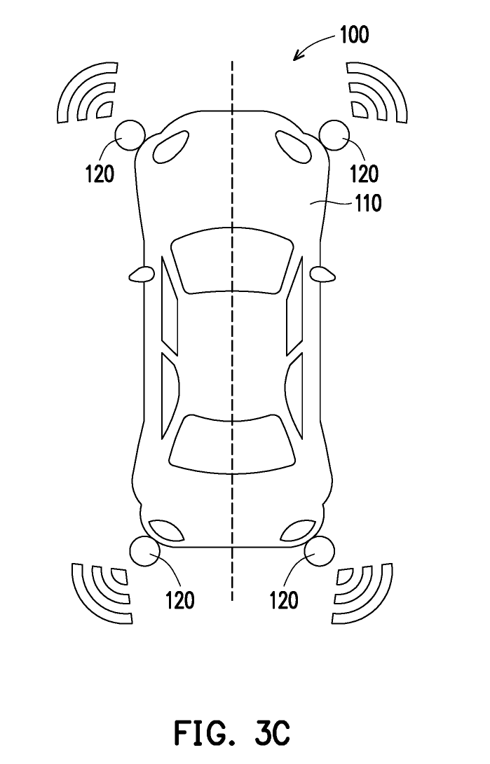

FIG. 3A through FIG. 3C are schematic views showing that the warning devices of the mobile carrier assembly alert when a person or an object approaches the mobile carrier, wherein the warning devices are mounted at different positions of the mobile carrier. Referring to FIG. 2 and FIG. 3A to FIG. 3C, no matter whether the mobile carrier 110 is in a moving state or in a stopped state, the energy harvesting unit 122 may continuously absorb solar energy from the sunlight in the daytime, transmit electricity to the battery 123 after converting the received light into the electricity, such that the battery 123 may supply the electricity to the object sensor 124 and the warning element 126. The energy harvesting unit 122 may absorb light from street lamps for photoelectric conversion in the nighttime.

Specially, when a person or an object approaches the mobile carrier 110 and enters the predetermined range capable of being sensed by the object sensor 124 of the warning device 120, the object sensor 124 sends out a signal to instruct the warning element 126 to issue an alert. When the warning element 126 uses a buzzer, the warning element 126 sends out a sound to warn the person approaching the mobile carrier 110. When the warning element 126 is an LED, the warning element 126 emits light to warn the person or the object approaching the mobile carrier 110. When the warning element is a combination of a buzzer and an LED, the person or the object approaching the mobile carrier 110 is warned by not only a sound but also the emitted light. In this way, the person or the object approaching the mobile carrier 110 may be warned more effectively, even though the one approaching the mobile carrier 110 is a blind or deaf person or object.

Accordingly, in comparison with the image-based or the radar-based vehicle detection system which warns the driver inside the mobile carrier 110 by internal alert of the mobile carrier 110, the warning devices 120 of the present embodiment are mounted at anywhere at the outside of the mobile carrier 110 to alert from the outside of the mobile carrier 110 to warn other people or objects approaching the mobile carrier 110.

Furthermore, the image-based or the radar-based vehicle detection system is usually limited to its mounted position and thus, the detection may be only performed on specific regions, for example, the rear side of the vehicle, which is limited by view angles of the lenses or detection ranges of radars. Nevertheless, the warning devices 120 of the present embodiment may be mounted at arbitrary positions at the outside of the mobile carrier 110 and thus, may be mounted at the left side, the right side and even the front side of the vehicle in addition to the rear side of the vehicle. In this way, each of the front, the rear, the left and the right sides of the vehicle may detect and alert through the warning devices 120, so as to avoid collision effectively.

Furthermore, an A-pillar of the vehicle may also block the driver's sight and becomes a blind spot of sight, and thus, the warning devices 120 may be mounted near the A-pillar.

Accordingly, because the warning device 120 uses simple elements and has a less complicated circuit design, the warning device 120 has low manufacturing cost and may be designed in a compact manner. In addition, for the user, the warning devices are not limited to be mounted at fixed positions at the outside of the mobile carrier 110 and thus, may be disposed as the user desires, while the range capable of being detected thereby is less limited. Moreover, no matter whether the vehicle is moving or parked on the roadside, the battery keeps being charged through the photoelectric conversion by the energy harvesting unit 122, such that the warning devices 120 have sufficient power to keep operating for detection and alerting.

FIG. 4 through FIG. 6 are circuit block views of the warning device 120 for blind spot detection according to different embodiments. Referring to FIG. 4, in the present embodiment, the warning device 120 may be further electrically connected with the mobile carrier 110. For example, the warning device 120 may be electrically connected with a central control computer 112 in the mobile carrier 110 via a Bluetooth signal for information exchange. In this way, the warning device 120 may alert the driver inside the mobile carrier 110 by means of voice, sound or light emission through the central control computer 112.

Referring to FIG. 5, the mobile carrier assembly 100 further includes a hand held electronic device 130. The hand held electronic device 130 is, for example, a smart cell phone of the driver or a passenger inside the mobile carrier 110, and the warning device 120 is further electrically connected with the hand held electronic device 130 by means of pairing an alert Bluetooth element 127 with the hand held electronic device 130. In this way, the warning device 120 may alert the driver or the passenger inside the mobile carrier 110 through the hand held electronic device 130.

The warning device 120 may be directly connected with the hand held electronic device 130, without the central control of the vehicle. This warning device 120 is more like a stand-alone small system.

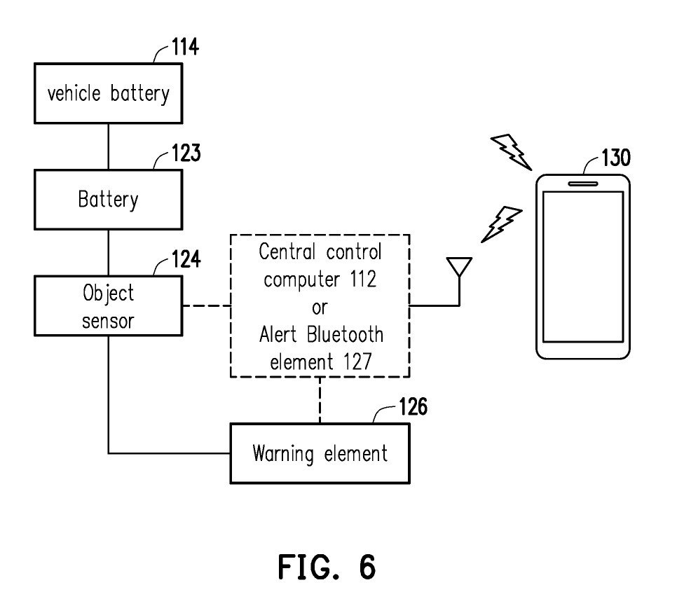

Referring to FIG. 6, the warning device 120 in the embodiment described above includes the battery 123 independently therein to supply electricity to the object sensor 124 and the warning element 126. However, in the embodiment illustrated in FIG. 6, a vehicle battery 114 is directly substituted for the energy harvesting unit 122, such that the vehicle battery 114 supplies electricity to the battery 123, the battery 123 then supplies electricity to the warning device 120, and the warning device 120 may be electrically connected with the hand held electronic device 130 by being paired with the central control computer 112 of the vehicle or through the alert Bluetooth element 127.

It should be additionally mentioned that although the mobile carrier 110 is illustrated as a vehicle for example in the present embodiment, the mobile carrier 110 is not limited to the vehicle exemplified in the present embodiment, and the mobile carrier 110 may also be a bicycle or even any mobile device such as a smart cell phone. For example, when the user mounts the warning device 120 on a smart cell phone and walks with the smart cell phone, the warning device 120 may alert when detecting that another person or object is present within the range, thereby warning the user to pay attention to the environment.

Based on the above, the warning device and the mobile carrier assembly using the warning device provided by the invention at least have the following advantages:

I. In comparison with the image-based or the radar-based vehicle detection system which warns the driver inside the mobile carrier by internal alert of the mobile carrier, the warning device of the invention is mounted at any position at the outside of the mobile carrier to alert from the outside of the mobile carrier to warn other people or objects approaching the mobile carrier.

II. Because the warning device uses simple elements and circuit design, the manufacturing cost is low, and the warning device can be designed in a compact manner.

III. The warning devices can be mounted at anywhere at the outside of the mobile carrier based on the user's demand, the price thereof is cheap, and thus, the number as used can be more than one, such that the range capable of being detected by the warning devices is not limited.

IV. No matter whether the vehicle is moving or parked on the roadside, the warning device can have sufficient power through the photoelectric conversion by the solar panel to keep operating for detection and alerting. When the vehicle using the warning device is moving or parked on the roadside, the warning device can detect and alert to warn other people outside the mobile carrier to actively dodge the mobile carrier when the people enter the predetermined range capable of being detected by the warning device.

Although the invention has been disclosed by the above embodiments, they are not intended to limit the invention. It will be apparent to one of ordinary skill in the art that modifications and variations to the invention may be made without departing from the spirit and scope of the invention. Therefore, the scope of the invention will be defined by the appended claims.

What is claimed is:

1. A warning device, adapted to be mounted at the outside of a mobile carrier, comprising:
an energy harvesting unit, used to retrieve an energy from an environment and convert the energy into an electrical energy;
a battery, electrically connected with the energy harvesting unit and used to store the electrical energy;
an object sensor, electrically connected with the battery and used to sense whether an object is present in a predetermined range; and
a warning element, electrically connected with the object sensor and used to issue an alert when the object sensor senses that an object is present in the predetermined range, wherein the alert comprises at least one of a sound and light.

2. The warning device according to claim 1, wherein the energy harvesting unit retrieves solar energy, wind power or thermoelectricity.

3. The warning device according to claim 1, wherein the object sensor is an infrared sensor.

4. The warning device according to claim 1, wherein the warning element is a buzzer, an LED or a combination of a buzzer and an LED.

5. A mobile carrier assembly, comprising:
a mobile carrier; and
a warning device, mounted at the outside of the mobile carrier and comprising:
an energy harvesting unit, used to retrieve an energy from an environment and convert the energy into an electrical energy;
a battery, electrically connected with the energy harvesting unit and used to store the electrical energy;
an object sensor, electrically connected with the battery and used to sense whether an object is present in a predetermined range; and
a warning element, electrically connected with the object sensor and used to issue an alert when the object sensor senses that an object is present in the predetermined range, wherein the alert comprises at least one of a sound and light.

6. The mobile carrier assembly according to claim 5, wherein the mobile carrier is a vehicle or a hand held electronic device.

7. The mobile carrier assembly according to claim 5, wherein the energy harvesting unit retrieves solar energy, wind power or thermoelectricity.

8. The mobile carrier assembly according to claim 5, wherein the object sensor is an infrared sensor.

9. The mobile carrier assembly according to claim 5, wherein the warning device is electrically connected with the mobile carrier.

10. The mobile carrier assembly according to claim 5, wherein the warning element is a buzzer, an LED or a combination of a buzzer and an LED.
